(19) United States
(12) Patent Application Publication
(10) Pub. No.: US 2008/0282570 A1
(43) Pub. Date: Nov. 20, 2008

(54) Using the vented hot air of the electric and gas clothes dryer to dry clothes on hangers &/or wire mesh &/or other means of holding clothes, in an enclosed compartment

(76) Inventor: Victor Ramirez Diaz De Rivera, Hacienda Hts., CA (US)

Correspondence Address: VICTOR DIAZ DE RIVERA, 2866 RIO LEMPA DR., HACIENDA HTS., CA, 91745, US

(21) Appl. No.: 12/153,055

(22) Filed: May 12, 2008

Related U.S. Application Data
(60) Provisional application No. 60/924,510, filed on May 17, 2007.

(51) Int. Cl. F26B 19/00

(52) U.S. Cl. 34/86

(57) ABSTRACT

Using the vented hot air of the electric and gas clothes dryer to dry clothes on hangers &/or wire mesh &/or other means of holding clothes, in an enclosed compartment. Also using hot air of said dryers that passed through the lint screen to dry clothes on hangers &/or wire mesh &/or others means of holding clothes, in an enclosed compartment.

By using said hot air, it is recycled thereby saving energy.

Using the vented hot air of the electric and gas clothes dryer to dry clothes on hangers &/or other means of holding clothes, in an enclosed compartment. The inventor is Victor Diaz De Rivera, an American citizen, residing At 2866 Rio Lempa Dr., Hacienda Heights, Calif. 91745.

I discovered that the Manufacturers of electric and gas clothes dryers are not utilizing the hot air vented out of said dryers. I intend to use this vented hot air to dry clothes on hangers &/or other means of holding clothes, in an enclosed compartment. This drying may or may not be supplemented by electric or gas drying.

I conclude with a claim on the use of the Vented hot air of electric and gas clothes or other materials dryers which I discovered the manufacturers of said dryers are not using except to vent it out.

I also claim the use of hot air passed thru The lint screen which I discovered the manufacturers of said dryers are not using except to vent it out.

The folowing are changes to the specification:

This is sent as a reply to the notice to file corrected application with regards to application no. 12/153,055 05/12/2008.

This should have a domestic priority data with which the application claims benefit of 60/924,510 05/17/2007.

I. I claim the use of the hot air vented out of electric and gas clothes dryers which I discovered the manufacturers of said dryers are not using except to vent it out.

II. I claim the use of the hot air passed thru the lint screen which I discovered the manufacturers of said dryers are not using except to vent it out.
